(19) United States
(12) Patent Application Publication
(10) Pub. No.: US 2007/0187378 A1
(43) Pub. Date: Aug. 16, 2007

(54) Device for carrying out a joint, separation, or suface treatment process, particularly a welding process

(76) Inventor: Erdogan Karakas, Burgwedel (DE)

Correspondence Address: SHLESINGER, ARKWRIGHT & GARVEY LLP, Suite 600, 1420 King Street, Alexandria, VA, 22314, US

(21) Appl. No.: 11/783,947

(22) Filed: Apr. 13, 2007

Related U.S. Application Data
(63) Continuation of application No. PCT/EP05/01060, filed on Feb. 3, 2005.

(30) Foreign Application Priority Data
Oct. 13, 2004 (DE) 10 2004 049 957.8

(51) Int. Cl. B23K 9/10; B23K 26/00

(52) U.S. Cl. 219/130.21; 219/121.63

(57) ABSTRACT

Device for carrying out one of a joint, separation, and surface treatment process includes a working head for acting on workpieces to be processed. There is likewise a sensor device for sensing one of a position and a positional change of the working head and one of a reference point in space relative to a reference position of the working head and to the workpiece to be processed, and in such a manner that at least one characteristic value of the one of the joint, separation, surface treatment process, can be influenced as a function of the one of the sensed position and the positional change, in use.

### CROSS-REFERENCE TO RELATED APPLICATIONS

This application is a continuation of application no. PCT/EP2005/001060, filed Feb. 3, 2005, which claims the priority of German application no. 10 2004 049 957.8, filed Oct. 13, 2004, and each of which is incorporated herein by reference.

### FIELD OF THE INVENTION

The invention relates to a device for carrying out a joint, separation, or surface treatment process, particularly a welding process. More particularly, the invention relates to a device including a working head for acting upon workpieces to be processed, particularly a welding head for outputting welding energy to workpieces to be welded.

### BACKGROUND OF THE INVENTION

These types of devices are generally known, in the form of welding devices, for example, and serve for example to carry out arc welding processes.

If, by way of an arc welding process, for example, a welding task is carried out which, in manufacturing a container for example, consists of making, without interrupting the arc, a continuous welding seam which includes a horizontal seam section (gravity position) to which there is connected a vertically running seam section (upwards position) connected to a horizontally running seam section (overhead position) and finally again connected to a vertically running weld section (downwards position), which connects to the first horizontally running weld section made, then it is necessary that during the welding operation, a worker operating the welding device change the position of the welding head relative to the workpieces to be welded.

To this end, it is desirable or necessary according to the circumstances to adjust values of characteristic values of the welding process to the respective position of the welding head. It is desirable, for example, to reduce the current strength of the welding current in the overhead position of the torch to prevent liquid material from dripping off a welding rod and the workpieces to be welded. It can furthermore be desirable, for example, to likewise reduce the current strength of the welding current in the upwards position and downwards position to thereby take into account the fact that in the upwards position and the downwards position the welding head is usually moved at a lower speed relative to the workpieces to be welded than in the gravity position.

For this purpose, it is known to use an operating device provided on the welding device to select different welding programs in which predetermined values are assigned to the characteristic values of the welding process, such as the amplitude of the welding current.

One disadvantage of this known welding device consists of it being necessary for the worker to select the appropriate welding program, in practice leading to the result that the worker, to save time and for convenience, may possibly carry out all parts of a welding task with the same welding program to avoid switching between the welding programs. Since one welding program can always be optimized only for one part of the welding task, such as welding in the gravity position, this leads in practice to the result that the quality of the welding seam is degraded in comparison to a welding seam that was made using the welding program respectively optimized for each welding section.

### OBJECTS AND SUMMARY OF THE INVENTION

The object of the invention is to provide a device which does not include the disadvantage of known devices, in which the work results in carrying out the joint, separation, or surface treatment process, such as in a welding process, is thus improved, in which the quality of the weld connection made is increased, and which is simple and comfortable to operate.

This object is achieved by the teaching according to the invention of a device for carrying out one of a joint, separation, and surface treatment process, including:
a) a working head for acting on workpieces to be processed; and
b) a sensor device for sensing one of a position and a positional change of the working head and one of a reference point in space relative to a reference position of the working head and to the workpiece to be processed, and in such a manner that at least one characteristic value of the one of the joint, separation, surface treatment process, can be influenced as a function of the one of the sensed position and the positional change, in use.

The basic idea of the teaching according to the invention, for example, and particularly in relation to a welding device, includes using a sensor device to sense the position of the welding head and/or positional changes of the welding head relative to a reference position of the working head and/or to a reference point in space and/or to the workpieces to be welded. In this manner, it is possible to influence the values of the characteristic values of the welding process or the value of at least one of these characteristic values as a function of the sensed position and/or positional change. In particular, values which are adjusted to the respective welding task can be assigned to the characteristic values of the welding process. To this end, the assignment of the values is performed according to the invention as a function of the sensed position and/or positional changes of the welding head that arises or arise, respectively, depending on what welding task is to be carried out.

In this manner, the operation of a device embodied as a welding device, for example, is substantially simplified and the quality of the weld connections, such as weld points or welding seams, produced by way of the device according to the invention is thus substantially increased. According to the invention, an optical or acoustical signal, which indicates to the worker that a different welding program must be selected, can be generated for example as a function of a sensed positional change of the welding head. If after making a welding seam in the gravity position, the welding head is rotated approximately 90° to weld in the upwards position for example, a signal can be generated indicating to the worker that a welding program optimized for welding in the upwards position must now be selected.

In particular and preferably, the influence on the values of characteristic values of the process concerned, such as a welding process, can also according to the invention occur automatically. For example, it is possible to provide a control device which detects the position of the working head or positional changes of the working head on the basis of output signals of the sensor device and influences the values of characteristic values of the process as a function of the detected position or positional change. The operation of the device according to the invention is substantially simplified in this manner and the quality of weld connections produced by use of a welding device according to the invention for example is substantially increased.

According to the invention, “working head” is understood to mean that part of a device according to the invention by which the workpieces to be processed are acted upon during the processing operation, thus for example by way of which the welding energy is introduced into the workpieces to be welded to one another during a welding operation. In a resistance welding process, the welding head can be formed by an electrode holder for example, while in an arc welding process it can be formed by a torch on which the welding rod is guided for example.

According to the invention, “welding operation” is understood to mean the operation of making a weld connection, thus a weld point or a welding seam for example.

The sensor device provided according to the invention can detect the position and/or positional changes of the working head relative to a reference position and/or a reference point in space according to the respective requirements, whereby the positional changes can be both translational and rotational positional changes as well as combinations of translational and rotational positional changes.

To this end, it is possible that positional changes of the working head are detected during working on one and the same workpiece. But it is also possible to detect positional changes in which another workpiece is acted upon after a positional change. If for example, a welding device carries out a welding task in relation to a first workpiece, then a change to another workpiece can be detected by the sensor device according to the invention and the value of at least one characteristic of the welding process can be adjusted to the welding task to be carried out in relation to this workpiece, possibly in cooperation with a manual intervention by the worker who, for example, inputs the welding task to be carried out on this workpiece into the device.

On the basis of the output signals of the sensor device, it is however also possible according to the invention to automatically carry out the recognition that a new workpiece is to be processed after a positional change and to automatically carry out the resulting adjustment of values of characteristic values of for example, a welding process, for example when a predetermined sequence of different workpieces spatially separated from one another are to be processed, and for example in the case of a predetermined sequence of workpieces to be welded separated from one another in the vertical direction.

The device according to the invention is particularly well suited for carrying out any desired welding procedure. In particular and for example, the welding process can be a resistance welding process, a beam welding process, a gas welding process, or an arc welding process, particularly an inert gas shielded arc welding process.

In relation to other joint, separation, or surface treatment processes, the basic idea of the teaching according to the invention includes influencing the characteristic values of the joint, separation, or surface treatment process as a function of the position or positional changes of the respective working head. The device according to the invention can accordingly also be embodied as any other desired joint, separation, or surface treatment device. For example, the device according to the invention can be embodied as a cutting device for carrying out a laser cutting process for example. The device according to the invention can also be configured as an adhesive device for carrying out an adhesive process for example, wherein the working head of the device can then be formed by a glue gun. Furthermore, the device according to the invention can also be configured as a paint spraying device, wherein the working head can then be formed by a paint spray gun or the like. According to the invention, the pressure with which the paint is sprayed can be increased in this case, for example, if the spray jet is directed upwards, work with the paint spray gun thus taking place above the head.

An exceptionally advantageous development of the teaching according to the invention provides for a control device connected to the sensor device for automatic open-loop and/or closed-loop control of at least one characteristic value of the joint, separation, or surface treatment process, particularly of the welding process, as a function of the position and/or positional changes of the working head sensed by the sensor device. This embodiment makes possible open-loop or closed-loop control of at least one characteristic value of the joint, separation, or surface treatment process, particularly of the welding process, as a function of the position and/or positional change of the working head sensed by the sensor device so that the operation of the device according to the invention is embodied in a particularly simple manner and the quality of a weld connection, for example, is further increased.

An advantageous development of the device according to the invention provides that the device is embodied as a welding device for carrying out a welding process and the working head is configured as a welding head for output of welding energy to the workpieces to be welded.

In the abovementioned embodiment, the influence of values of characteristic values of the joint, separation, or surface treatment process, particularly of the welding process, can proceed in any desired suitable manner.

An advantageous development provides that the control device is connected to a welding-energy source that provides welding energy to the welding head for controlling same in such a manner that it is possible to exercise open-loop and/or closed loop control at the welding-energy source on at least one characteristic value of the welding process as a function of the position and/or positional change of the welding head sensed by the sensor device. In this embodiment, the open-loop or closed-loop control of characteristic values of the welding process is exercised on the welding-energy source. To this end, the control device can be integrated into a controller of the welding-energy source or can be formed by a separate controller that is connected to the sensor device on the input side and connected to a controller of the welding-energy source on the output side.

Number, arrangement and structural design of sensors of the sensor device can be selected within wide boundaries. An advantageous development of the teaching according to the invention provides that the sensor device includes at least one sensor for sensing a rotational position and/or a rotational positional change of the working head. In this embodiment the sensor can establish, for example, whether the working head is rotating in order, for example, to transition from welding in the gravity position to welding in the upwards position in a welding device.

Another development of the teaching according to the invention provides that the sensor device includes at least one sensor for sensing translational positional changes of the working head. In this embodiment, the sensor can sense whether the working head is moving translationally, such as when making a welding seam.

Any desired suitable sensors or sensor arrangements can be used for sensing translational positional changes of the working head. For example, an ultrasonic sensor, which emits ultrasonic waves that are received by a stationary ultrasonic receiver, can be arranged on the working head. The distance of the working head from the ultrasonic transmitter can be determined from the echo time of the ultrasonic waves from the ultrasonic transmitter and thereby from the working head to the ultrasonic receiver. In a manner corresponding to this, the ultrasonic waves can be received by two ultrasonic receivers arranged spatially separated from one another so that translational positional changes of the working head can be determined on the basis of the change in distance of the working head to each of the two ultrasonic receivers. To distinctly detect positional changes of the working head in three-dimensional space, three ultrasonic receivers that are spatially separated from one another can be provided in a thereto corresponding manner so that the position of the working head in three-dimensional space or positional changes can be distinctly detected from the respective distance of the working head from each of the ultrasonic receivers. In particular, translational positional changes can also be detected, for example with an optical sensor device. The distance of the working head from a reference point can be determined, for example, by use of a laser interferometer. In a thereto corresponding manner, translational positional changes of the working head can be detected by two laser interferometers that are independent of each other and positional changes of the working head in three-dimensional space by use of three laser interferometers that are independent of each other.

A development of the abovementioned embodiment provides that the sensor senses the speed and/or acceleration of a translational and/or rotational movement of the working head. In this manner, a more extensive influence of characteristic values of the welding process can occur. For example, in a welding device the amplitude of the welding current can be influenced as a function of the speed at which the welding head moves over the workpieces to be welded to one another when making a weld connection. When welding with a relatively low speed of the welding head relative to the workpieces to be welded, a predetermined amplitude of the welding current can be selected to keep constant the so-called energy per section, the welding energy per unit length of a welding seam introduced into the workpieces to be welded, while the amplitude of the welding current is increased when the speed is increased. To sense an acceleration of the working head, it is possible to use sensors for example like those sold by Freescale Semiconductor, Inc., Alma School Road, Chandler, Ariz., USA (www.freescale.com) under the designations MMA 6260 Q, MMA 6261 Q, MMA 6262 Q and MMA 6263 Q.

In accordance with the respective requirements, during the processing operation the working head can be managed by hand or by handling equipment, particularly a welding robot.

In the embodiment in which the device is a welding device for carrying out a welding process, the welding process can be a resistance welding process, a beam welding process, a gas welding process, an arc welding process, an inert gas shielded arc welding process, a stud welding process, or a laser-beam welding process.

To carry out a welding process in which the welding energy is supplied by a welding current or a welding voltage, a development of the teaching according to the invention provides that the influenceable characteristic values of the welding process include at least
the amplitude and/or
the signal shape, especially pulse shape and/or
the pulse frequency and/or
the pulse modulation
   of a welding current and/or a welding voltage, the values being influenceable as a function of a position and/or of a positional change of the welding head sensed by the sensor device.

If the welding device is used to carry out a resistance welding process, then an advantageous development of the invention provides that the influenceable characteristic values of the welding process include a contact pressure of at least one welding electrode of the welding head on one of the workpieces to be welded, the values being influenceable as a function of a position or positional change of the welding head sensed by the sensor device.

An advantageous development of the welding device according to the invention which is used for carrying out an arc welding process, in which additional material is supplied in the form of a welding rod, provides that the influenceable characteristic values of the welding process include a feed speed of at least one welding rod guided on the welding head, the values being influenceable as a function of a position and/or positional change of the welding head sensed by the sensor device.

Another advantageous development of the teaching according to the invention provides that the device is a welding torch.

Other developments of the teaching according to the invention provide that the device is a paint spraying device, especially a paint spraying gun, or an adhesive device, such as a hot-glue gun.

The position of a sensor or of sensors of the sensor device relative to the working head can be selected in any desired suitable manner as long as it is ensured that the position or positional changes of the working head can be detected in the required manner. To make possible a particularly accurate detection of the position or of positional changes of the working head and to simultaneously achieve a structurally simple construction, a development of the teaching according to the invention provides that at least one sensor of the sensor device is arranged on the working head, in particular integrated into the working head.

But according to the invention it is also possible that at least one sensor of the sensor device can be worn on the body of a worker using the device, especially on his/her hand or arm, as provided for in another development of the teaching according to the invention.

A reference position of the working head can already be preset by the factory during the manufacture of the device according to the invention. The reference position can for example be a position in which a welding head is arranged in such a manner that welding is performed in the gravity position, thus making a welding seam running essentially horizontal. An advantageous development of the teaching according to the invention provides, however, that the reference position of the working head and/or a reference point in space can be selected by a worker and/or by the control device. In this embodiment, it is possible in particular to adjust the reference position to the circumstances of the respective welding task or to a worker using the welding device.

A development of the abovementioned embodiment provides that the control device assigns predetermined values to the characteristic values of the welding process as a function of the selected reference position and/or of positional changes of the working head. In this embodiment, values corresponding to a characteristic curve for example can be assigned to the characteristic values of the welding process. In the welding of metal sheets of a particular thickness, for example, one set of values of the characteristic values can respectively be assigned to welding in the gravity position, to welding in the upwards position, to welding in the overhead position and to welding in the downwards position. But it is also possible to perform the assignment of values to the characteristic values of the welding process as a function of a characteristics field. Thus for example, values can be assigned to the characteristic values as a function of the material and/or the thickness of the workpieces to be welded to one another.

Another advantageous development of the teaching according to the invention provides that the control device automatically exercises open-loop or closed-loop control of the characteristic values of the welding process during the welding operation. The open-loop or closed-loop control of the characteristic values can be performed continuously or discretely in a temporal or spatial manner relative for example to a welding seam.

Another development of the teaching according to the invention provides for a display device for displaying an operating mode of the device selected by the control device as a function of output signals of the sensor device. In this embodiment, an operating mode of the device, such as a welding program selected by the control device, can be displayed by the display device so that the worker is informed with what welding program he/she is now welding. In addition, the display of the current operating mode allows the worker to check the method of function of the sensor device and of the control device for plausibility and thus to recognize malfunctions for example.

In principle it is particularly advantageous if an influence of characteristic values of the joint, separation, or surface treatment process occurs automatically by use of the control device so that no manual intervention by the worker is required and it is ensured at the same time that the device is always in a suitable operating mode, such as welding with a welding program adjusted to the current position of the welding head in the case of a welding device for example. If, in addition to an automatic influence of characteristic values of the joint, separation, or surface treatment process by the control device, manual intervention by the worker is to be permitted, then an advantageous development of the teaching according to the invention provides for an operating device for the manual selection of an operating mode of the device. This embodiment is also particularly advantageous when an influence of the influencing characteristic values does not occur fully automatically by use of the control device, but it is displayed to the worker, as a function of output signals of the sensor device, that it is necessary to select another operating mode of the device, another welding program in the case of a welding device for example, the selection of the operating mode nevertheless being performed manually by a worker and the characteristic values of the process being influenced as a result of this selection.

Another advantageous development of the teaching according to the invention provides that the control device influences the characteristic value or values in such a manner that the process can be carried out without interruption. In this embodiment, the influence of the characteristic values and thereby the selection of a suitable operating mode in the case of an arc welding process, for example, occurs in such a manner that welding can proceed without interrupting the arc. In this connection, it is essential that an influence of values of the characteristic values occurs so quickly that, in the case of a welding device for example, work is performed with values of the characteristic values adjusted to the current weld position during the transition from the gravity position into the upwards position.

In the abovementioned embodiment, the control device can influence the characteristic value or values in a time-continuous or time-discrete manner, as provided in this development of the teaching according to the invention.

According to the invention, it is sufficient for the sensor device to sense the position or positional changes of the working head along one axis, one-dimensionally, or in one plane, two-dimensionally. A particularly advantageous development of the teaching according to the invention provides however that the sensor device detects the spatial position and/or spatial positional changes of the working head in three-dimensional space. In this embodiment, the position or positional change of the working head can be detected particularly accurately, so that there are various possibilities in regard to the influence of the characteristic values.

Another development of the teaching according to the invention provides that different values of at least one characteristic value are assigned to different positions of the working head and that the control device assigns a value to the respective characteristic value as a function of the position of the working head sensed by the sensor device.

Another development of the teaching according to the invention provides that a first value of at least one characteristic value is assigned to at least one first position of the working head and that a second value of the characteristic value or values is assigned to at least one second position of the working head and that the control device assigns the first value to the characteristic value when an output signal of the sensor device indicates that the working head is in the first position and that the control device assigns the second value to the characteristic value when an output signal of the sensor device indicates that the working head is in the second position.

In the following, the invention will be explained in more detail on the basis of the enclosed drawing in which exemplary embodiments of a welding device according to the invention are illustrated. To this end, all features described or illustrated in the drawing, per se or in any combination, form the subject matter of the invention independently of their summarization in the claims or their back references and independently of their wording or illustration in the description and drawing respectively.

### BRIEF DESCRIPTION OF THE DRAWINGS

FIG. 1 is a highly schematic block diagram of a first exemplary embodiment of a device according to the invention in the form of a welding device for carrying out an arc welding process,

FIG. 2 shows in the same representation as in FIG. 1, a second exemplary embodiment of a welding device according to the invention,

FIG. 3 is a highly schematic of an exemplary embodiment of a sensor for detecting the rotational position or rotational positional changes of the welding head of the welding device as per FIG. 1,

FIG. 4 is a highly schematic second exemplary embodiment of a sensor for detecting a rotational position or rotational positional changes of the welding head,

FIG. 5 shows the welding head when welding in the gravity position in a first rotational position,

FIG. 6 shows in the same representation as in FIG. 5, the welding head when welding in the gravity position in a second rotational position,

FIG. 7 shows the welding head when welding in the upwards position in a first rotational position,

FIG. 8 shows the welding head when welding in the upwards position in a second rotational position,

FIG. 9 shows the welding head when welding in the overhead position,

FIG. 10 shows a characteristics field for assigning values to the characteristic values, and

FIG. 11 is a highly schematic representation of a container comprising a plurality of metal sheets to be welded to one another for the purpose of explaining a process according to the invention.

### DETAILED DESCRIPTION OF THE INVENTION

In the Figs. the same or mutually corresponding components are provided with the same reference numerals.

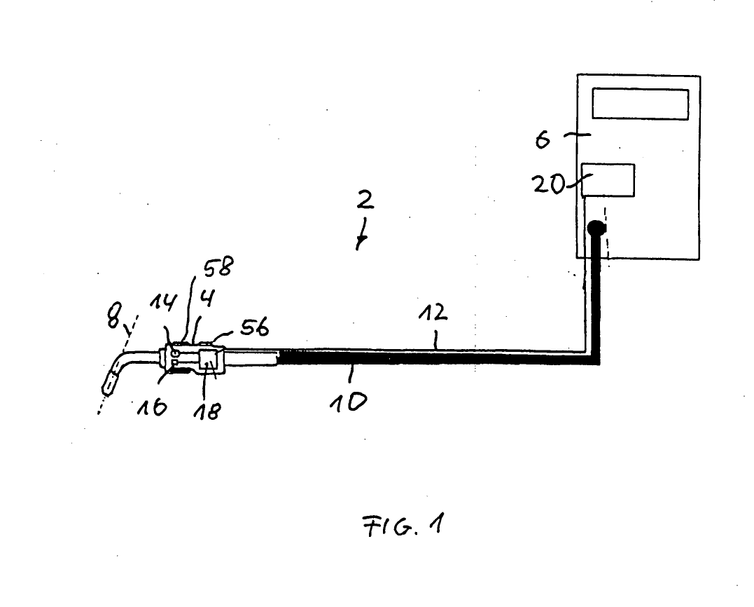

FIG. 1 depicts a first exemplary embodiment of a device according to the invention in the form of a welding device 2, which in this embodiment is configured to carry out an arc welding process, and which includes a welding head 4 configured as a welding torch for outputting welding energy to workpieces to be welded. A welding-energy source 6, which supplies a welding current to the welding head 4, is provided to supply the welding head 4 with welding energy. The welding current flows through a welding rod, which in FIG. 1 is indicated by a dashed line 8, and which is continuously fed to the welding head 4 during the welding operation, and which forms an electrode in the arc welding process, whereby in making a weld connection, such as a welding seam, an arc burns between the welding rod 8 and the workpiece to be welded. The welding current is supplied to the welding head 4 via a supply line 10. A control line 12 is provided to transmit control signals from the welding head 4 to the source 6.

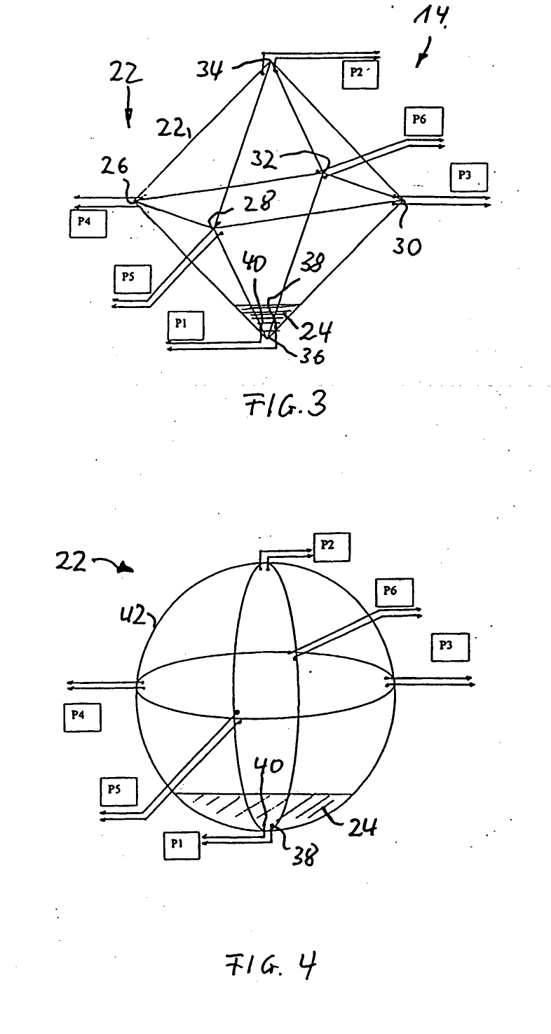

According to the invention, the welding device 2 includes a sensor device for sensing the position or positional changes of the welding head 4 relative to a reference position of the welding head 4 and/or to the workpieces to be welded in such a manner that at least one characteristic value of the welding process can be influenced as a function of the sensed position and/or positional changes. In this exemplary embodiment, the sensor device includes a first sensor 14 for sensing a rotational position and/or rotational positional changes of the welding head 4, which will be explained in greater detail below on the basis of FIGS. 3 and 4.

In this exemplary embodiment, the sensor device further includes a second sensor 16, which senses translational movements and the speed and/or acceleration of a translational movement of the welding head.

In this exemplary embodiment, the sensors 14, 16 are integrated into the welding head. The welding device 2 furthermore according to the invention includes a control device connected to the sensors 14, 16 for automatic open-loop and closed-loop control of at least one characteristic value of the welding process as a function of the position and/or positional changes of the welding head 4 sensed by the sensors 14, 16. In this exemplary embodiment, the control device includes a control unit 18, whereby output signals of the sensors 14, 16 form input signals of the control unit 18 whose output signals are supplied to a controller 20, which is integrated into the source 6 and performs open-loop or closed-loop control of characteristic values of the welding process, particularly of the amplitude of the welding current delivered to the welding head 4 by the source 6, as a function of the output signals of the control unit 18.

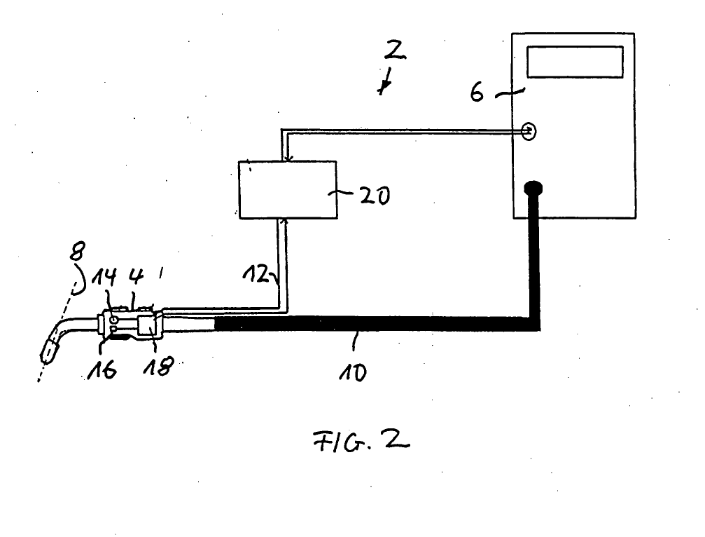

FIG. 2 depicts a second exemplary embodiment of a welding device 2 according to the invention, which differs from the exemplary embodiment as per FIG. 1 in that the controller 20 is not integrated into the source 6, but is configured as a separate controller.

FIG. 3 illustrates the method of functioning of the first sensor 14 in a highly schematic manner. The first sensor 14 includes a housing 22, which is configured as a hollow body and which, in this exemplary embodiment, essentially has the shape of a regular octahedron, the interior of which accommodates a small amount of mercury 24. A pair of electrical contacts, only one pair of which is provided with the reference characters 38, 40 in FIG. 1, is arranged in the vicinity of each of the apexes 26, 28, 30, 32, 34, 36 of the octahedron. If the mercury 24 collects in the vicinity of apex 36 of housing 22 for example, this produces an electrically conducting connection between contacts 38 and 40 so that a control current, for example, can flow between the contacts 38, 40, the control unit 18 recognizing on the basis of this control current that the mercury 24 has collected in the vicinity of the apex 36. In this manner it can be established in control unit 18 that the housing 24 is situated in the rotational position depicted in FIG. 1. Since the first sensor 14 is arranged on the welding head 4 in a nonrotatable fashion, it can be recognized in this manner that the welding head 4 is situated in the position depicted in FIG. 1.

If the welding head 4 is rotated 90° clockwise around a rotational axis running perpendicular to the plane of the drawing in FIG. 1, then the mercury 24 will collect in the vicinity of apex 30 and produce an electrically conducting connection between the contacts assigned to this apex 30 so that a control current can flow between these contacts. In this manner, the control unit 18 can establish that the housing 22, and therefore also welding head 4, is situated in a rotational position that is rotated 90° clockwise relative to FIGS. 1 and 3. In a thereto corresponding manner, it is possible to recognize any changes of the rotational position of housing 22 and thereby welding head 4 around all three axes in space.

The arrangement of pairs of contacts 38, 40 on the apexes 26, 28, 30, 32, 34, 36 of the housing is to be understood as exemplary only. To engineer the recognition of positional changes more accurately, additional pairs of contacts 38, 40 can be provided.

In addition, while keeping the basic principle of the first sensor 14 depicted in FIG. 3, its housing 20 can be also embodied differently, such as a sphere 42 as depicted in FIG. 4. By appropriate selection of the number and arrangement of the pairs of electrical contacts 38, 40, a particularly accurate recognition of changes of the rotational position of the housing 22 of the first sensor 14 and therefore of the welding head 4 is made possible.

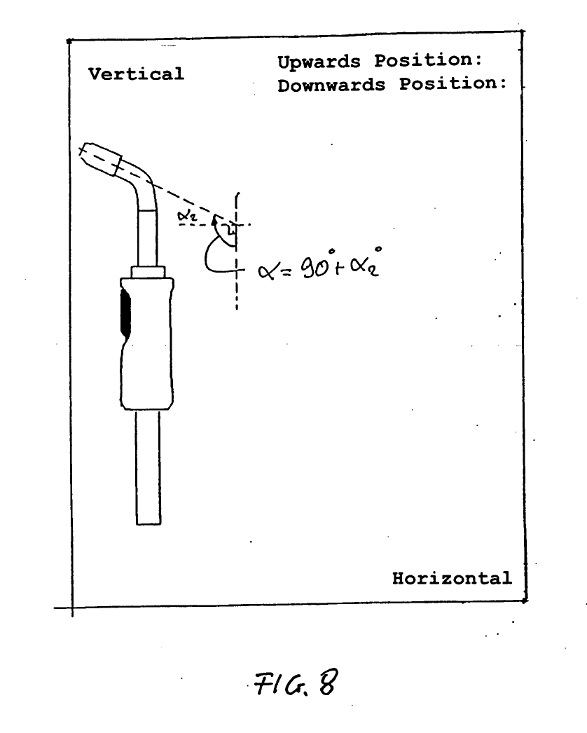

The method of function of the device according to the invention will be explained in more detail below based on FIGS. 5 to 9.

For the sake of example, the welding of four plates 44, 46, 48, 50, which in FIG. 5 extend perpendicularly to the plane of the drawing, to a fifth plate 52, which in FIG. 5 lies in the plane of the drawing, will be described.

To weld plate 44 to plate 52, the welding head 4 in FIG. 5 is moved left in the direction of an arrow 54 along the joint area of the plates 44, 52, whereby an arc forms between the welding rod, which is not illustrated in FIG. 5, and the plates 44, 52 to be welded to one another, the arc leading to the formation of a weld connection in the form of a welding seam. To this end, the source 6 supplies a welding current with an amplitude of 150 A, for example, to the welding head 4. During the welding operation, the first sensor 14 senses the rotational position of the welding head 4 relative to the reference position illustrated in FIGS. 1 and 5, while the second sensor 16 senses the speed of the motion of the welding head 4 in the direction of the arrow 54.

If on the basis of the output signal of the second sensor 16, it is established that a worker is increasing the speed at which the welding head 4 moves in the direction of arrow 54, then the control unit 18 transmits a corresponding signal to the controller of the source 6, which thereupon increases the amplitude of the welding current to keep the energy per section constant. If in contrast, the second sensor 16 establishes that the speed at which the welding head 4 is moving in the direction of arrow 54 is decreasing, then the control unit 18 transmits to the controller 20 a corresponding signal that thereupon reduces the amplitude of the welding current provided by the source 6. In this manner, it is ensured that the energy per section remains constant during the welding operation.

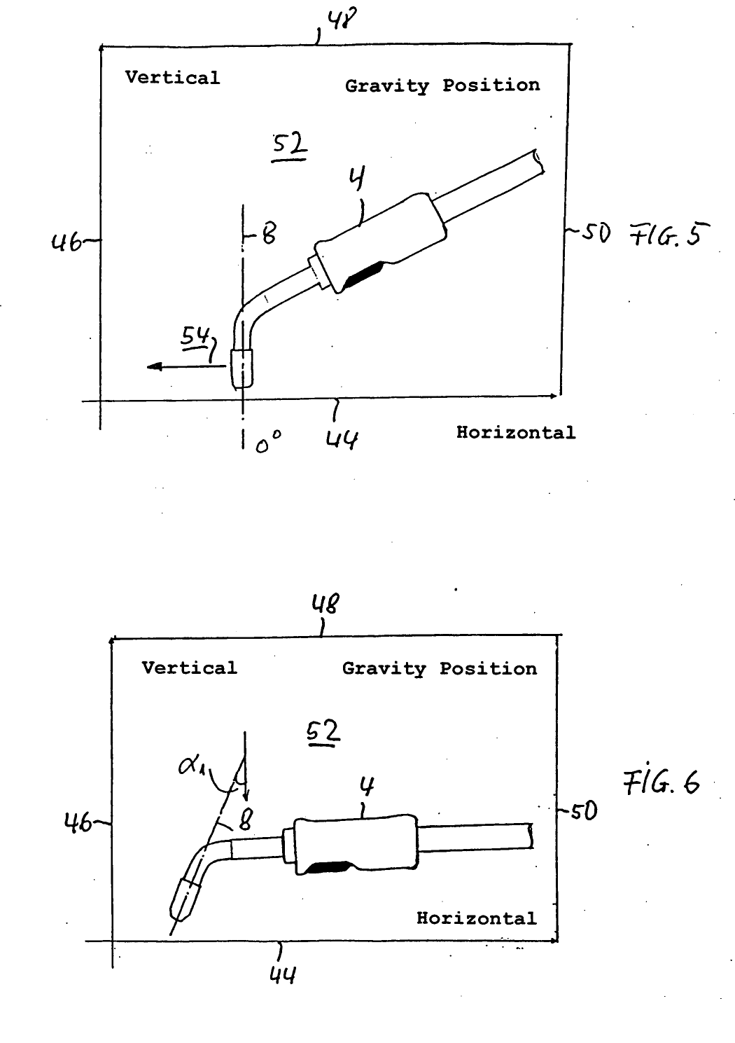

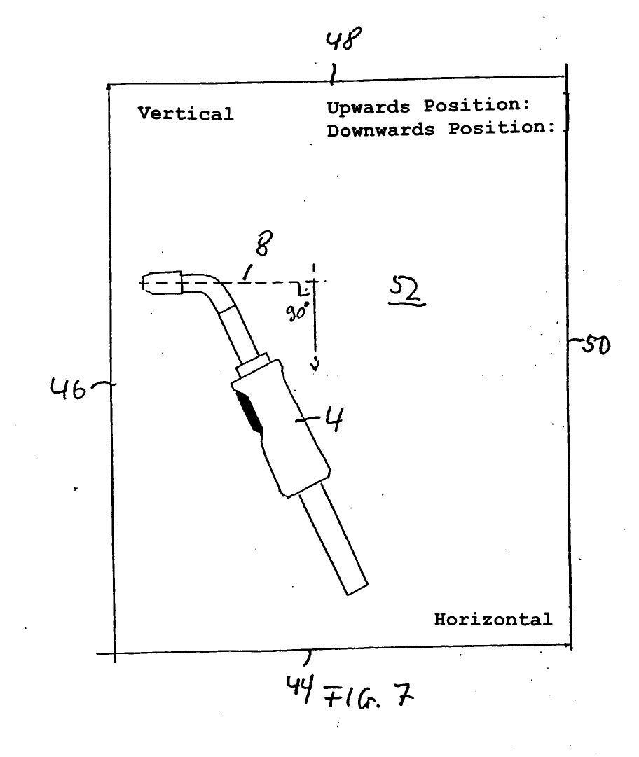

If the rotational position of the welding head 4 is changed around an axis running perpendicular to the plane of the drawing for example, as depicted in FIG. 6, then the first sensor 14 detects this change of the rotational position and control unit 18 transmits a corresponding signal to the controller 20. The controller 20 can then influence at least one characteristic value of the welding process, again the amplitude of the welding current for example, in order to obtain an optimal welding result.

If the welding head 4 is rotated anew around an axis running perpendicular to the plane of the drawing in order to make a welding seam between the plate 46 and plate 52, and welding is accordingly performed in the upwards position, then the first sensor 14 detects the change of the rotational position, and the control unit 18 transmits a corresponding signal to the controller 20 of the source 6. Since welding in the upwards position occurs at a lower speed than welding in the gravity position, the controller 20 thereupon reduces the welding current, which can then amount to 90 A for example. If the second sensor 16 establishes that the welding head is not moving at an essentially constant speed along the welding seam to be made, but is moving intermittently between stop and subsequent acceleration, then the controller 20 can control the welding current in such a manner that a relatively high welding current is used during a movement of the welding head 4 at relatively high speed and a reduced welding current is used during a movement of the welding head 4 at relatively low speed, particularly at stop.

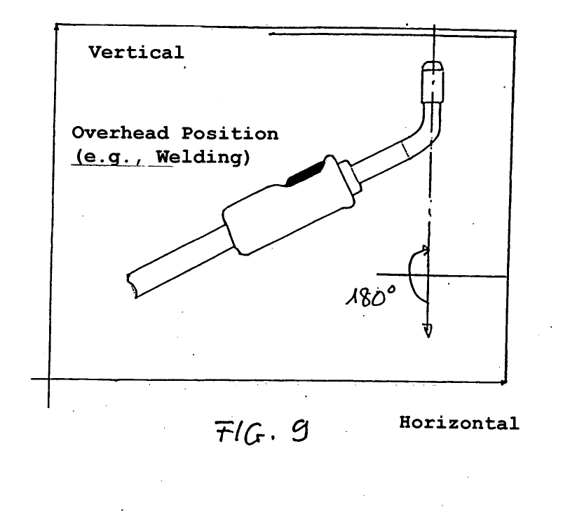

If the welding head 4 is rotated anew around an axis running perpendicular to the plane of the drawing, as depicted in FIG. 8, then the controller 20 can again influence at least one characteristic value of the welding process, such as the amplitude of the welding current, increasing it for example, as a function of the output signal of the sensors 14, 16 and the output signal of the control unit 18 arising therefrom.

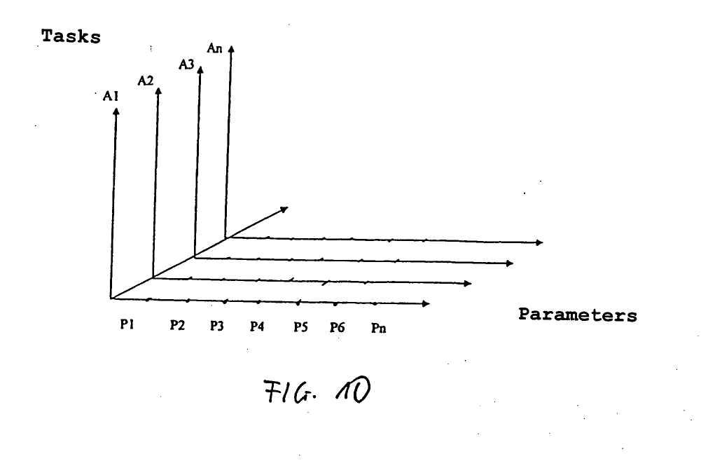

If it is established on the basis of the output signal of the first sensor 14 that the welding head 4 was again rotated around an axis running perpendicular to the plane of the drawing and now assumes the rotational position depicted in FIG. 9 in which the welding head 4 is rotated by 180° relative to the reference position depicted in FIG. 5, then it follows that the welding head 4 is being used to weld in the overhead position. The controller 20 of the source 6 thereupon reduces the amplitude of the welding current as a function of a corresponding output signal of the first sensor 14 and a thereupon resulting output signal of the control unit 18 so far that the material of the plates 48, 52 to be welded together are liquefied just as much as needed to make a weld connection while still keeping the material from dripping off at the same time. The amplitude of the welding current can be reduced to 80 A, for example, when welding in the overhead position.

In a thereto corresponding manner, the welding current can be increased again if it is established on the basis of the output signal of the first sensor 14 that the welding head 4 is rotated anew to make a welding seam between the plate 50 and the plate 52 in the downwards position.

Thus the welding seams needed to connect the plates 44, 46, 48, 50 can be made without interrupting the arc, whereby in the exemplary example of the welding current, the influence of characteristic values of the welding process is performed automatically by control unit 18 and controller 20 as a function of output signals of the sensors 14, 16 of the sensor device, without a manual intervention of a worker being required. To this end, the controller 20 can be pre-programmed in such a manner that the welding result is optimized as a function of the respective position or positional change of the welding head 4.

Since the influence of characteristic values of the welding process occurs automatically, a manual intervention of a worker is basically not required. To permit a manual intervention by a worker, an operating device 56 (see FIG. 1), such as a particular welding program to be manually selected, can be provided if necessary, and a display device 58 can display the respectively selected welding program.

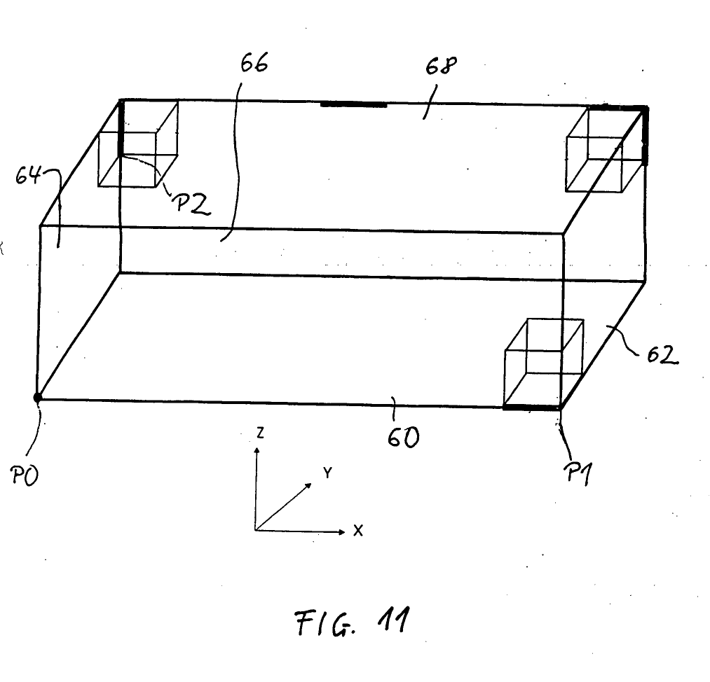

FIG. 10 depicts a characteristics field, in which A1 to An denote different welding tasks and P1 to Pn denote different positions of the welding head. In this characteristics field, the assignment of values of the characteristic values can be provided as a function of the respective welding task and as a function of the respective position of the welding head, whereby the welding tasks can differ, for example, in regard to the thickness and/or to the material of the workpieces to be welded together.

FIG. 11 depicts in highly schematic form a container that is made of metal sheets to be welded to one another.

Prior to carrying out welding operations by use of the welding device 2, which is not illustrated in FIG. 11, this device is first moved to a reference point P0. As part of a learning mode of the welding device 2, it has been predetermined in advance and stored in memory that a first welding task, namely making a welding seam in the gravity position between a bottom plate 60 and a vertical side plate 62, is to be carried out starting from a point P1, that a second welding task, namely making a welding seam as an upward seam between a vertical side plate 64 and a vertical side plate 66 is to be carried out starting from a point P2, and that a third welding task, namely making a welding seam as an overhead seam between the vertical side plate 66 and an upper plate 68, is to be carried out starting from a point P3.

To this end, the welding device 2 according to the invention is first moved to the reference point P0 and the arrival at the reference point P0 is indicated to the control device by actuating a key of the operating device 56, for example. If the welding device 2 is moved starting from the reference point P0, then the sensor device detects the position and/or positional changes of the welding device in three-dimensional space. If the welding device is moved along the X axis, for example, then the sensor device detects this movement. When point P1 has been reached, the control device assigns, to the characteristic values of the welding process, values that are optimally adjusted to the welding task to be carried out there, namely welding in the gravity position. The worker can thus produce the welding seam between the vertical side plate 62 and the bottom plate 60.

If the welding device is then subsequently moved in the direction of point P2, the sensor device newly senses the position of the working head of the welding device 2 or positional changes in three-dimensional space. Arrival at point P2 is indicated to the control device by appropriate output signals of the sensor device, whereby the control device thereupon assigns, to the characteristic values of the welding process, values that are optimally adjusted to the welding task to be carried out starting from point P2, namely making a welding seam as an upward seam between the metal sheets 64, 68. The worker can then subsequently make the corresponding welding seam.

If the welding device 2 is then subsequently moved in the direction of point P3, the sensor device will newly sense the position of the working head 4 of the welding device 2 or positional changes in three-dimensional space. If output signals of the sensor device indicate to the control device that the welding head 4 of the welding device 2 is situated at point P3, then the control device thereupon assigns, to the characteristic values of the welding process, values that are optimally adjusted to the welding task then to be carried out, namely making a welding seam in the overhead position. The worker can then subsequently make the corresponding welding seam.

In this manner, a fully automatic location detection of the position of welding head 4 of welding device 2 and a fully automatic adjustment of values of the characteristic values of the welding process to the welding task to be carried out is carried out. To this end, any desired characteristic values of the welding process can be called upon and influenced. It is thus possible, for example, to incorporate into the influence of the characteristic values not only the specific position of welding head 4 but also, for example, the thickness of the metal sheets to be welded to one another. In regard to two similar welding tasks that are to be carried out at different locations but that each relate to welding in the gravity position for example, it is possible in carrying out the first task to work with a welding current that is adjusted to welding thicker metal sheets to one another for example, while working on the second welding task with a welding current that is adjusted to welding thinner metal sheets. In this manner, there results particularly high flexibility in influencing the characteristic values.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention or limits of the claims appended hereto.

1. Device for carrying out one of a joint, separation, and surface treatment process, comprising:
a) a working head for acting on workpieces to be processed; and
b) a sensor device for sensing one of a position and a positional change of the working head and one of a reference point in space relative to a reference position of the working head and to the workpiece to be processed, and in such a manner that at least one characteristic value of the one of the joint, separation, surface treatment process, can be influenced as a function of the one of the sensed position and the positional change, in use.

2. Device according to claim 1, comprising:
a) a control device connected to the sensor device for one of automatic open-loop and closed-loop control of at least one characteristic value of the one of the joint, separation, and surface treatment process, as a function of the one of the position and positional change of the working head.

3. Device according to claim 2, wherein:
a) the device is configured as a welding device for carrying out a welding process on the workpiece, in use; and
b) the working head is configured as a welding head for output of welding energy to the workpiece to be welded, in use.

4. Device according to claim 3, wherein:
a) the control device is connected to a welding-energy source that provides welding energy to the welding head for controlling the welding head in such a manner that it is possible to exercise one of open-loop and closed loop control at the welding-energy source on at least one characteristic value of the welding process as a function of the one of the position and positional change of the welding head sensed by the sensor device.

5. Device according to claim 2, wherein:
a) the sensor device includes at least one sensor for sensing one of a rotational position and a rotational positional change of the working head.

6. Device according to claim 2, wherein:
a) the sensor device includes at least one sensor for sensing translational positional changes of the working head.

7. Device according to claim 5, wherein:
a) the sensor senses one of a speed and an acceleration of a translational and a rotational movement of the working head.

8. Device according to claim, wherein:
a) the working head is configured for being managed by one of hand and by a handling device, during the processing operation.

9. Device according to claim 3, wherein:
a) the welding process is a beam welding process.

10. Device according to claim 3, wherein:
a) the welding process is a gas-welding process.

11. Device according to claim 3, wherein:
a) the welding process is an arc welding process.

12. Device according to claim 11 wherein:
a) the welding process is an inert gas shielded arc welding process.

13. Device according to claim wherein:
a) the welding process is a stud welding process.

14. Device according to claim 3, wherein:
a) the welding process is a laser-beam welding process.

15. Device according to claim 4, wherein:
a) the at least one characteristic value of the welding process includes at least one of:
i) the amplitude;
ii) the signal shape;
iii) the pulse frequency; and
iv) the pulse modulation of one of a welding current and a welding voltage, the at least one characteristic value being influenceable as a function of one of the position and the positional change of the welding head sensed by the sensor device.

16. Device according to claim 14, wherein:
a) the influenceable characteristic values of the welding process include a contact pressure of at least one welding electrode of the welding head on one of the workpieces to be welded.

17. Device according to claim 14, wherein:
a) the influenceable characteristic values of the welding process include a feed speed of at least one welding rod guided on the welding head, in use.

18. Device according to claim 3, wherein:
a) the device is a welding torch.

19. Device according to claim 1, wherein:
a) the device is a paint spraying device.

20. Device according to claim 1, wherein:
a) the device is an adhesive device.

21. Device according to claim 1, wherein:
a) at least one sensor of the sensor device is provided on the working head.

22. Device according to claim 1, wherein:
a) at least one sensor of the sensor device can be worn on the body of a worker using the device.

23. Device according to claim 2, wherein:
a) the one of the reference position of the working head and a reference point in space can be selected by one of a worker and by the control device, in use.

24. Device according to claims 4, wherein:
a) the control device assigns predetermined values to the characteristic values of the process as a function of one of the selected reference position and the one of the position and positional changes of the working head sensed by the sensor device.

25. Device according to claim 2, wherein:
a) the control device automatically exercises one of open-loop and closed-loop control of the characteristic values of the process during the processing operation.

26. Device according to claim 2, wherein:
a) a display device is provided for displaying an operating mode of the device selected by the control device as a function of output signals of the sensor device.

27. Device according to claim 1, wherein:
a) an operating device is provided for the manual selection of an operating mode of the device.

28. Device according to claim 2, wherein:
a) the control device influences the at least one characteristic value in such a manner that the process is carried out without interruption.

29. Device according to claim 2, wherein:
a) the control device influences the at least one characteristic value in a time-continuous manner.

30. Device according to claim 2, wherein:
a) the control device influences the at least one characteristic value in a time-discrete manner.

31. Device according to claim 1, wherein:
a) the sensor device detects one of a spatial position and a spatial positional change of the working head in three-dimensional space.

32. Device according to claim 4, wherein:
a) different values of the at least one characteristic value of the joint, separation, or surface treatment process are assigned to different positions of the working head; and
b) the control device assigns a predetermined value to the respective at least one characteristic value as a function of the position of the working head sensed by the sensor device.

33. Device according to claim 4, wherein:
a) a first value of the at least one characteristic value is assigned to at least one first position of the working head, and a second value of the at least one characteristic value is assigned to at least one second position of the working head; and
b) the control device assigns the first value to the at least one characteristic value when an output signal of the sensor device indicates that the working head is in the first position and assigns the second value to the at least one characteristic value when an output signal of the sensor device indicates that the working head is in the second position.
